(19) United States
(12) Patent Application Publication
(10) Pub. No.: US 2026/0278991 A1
(43) Pub. Date: Sep. 17, 2026

(54) OBJECT RECOGNITION DEVICE, AND OBJECT RECOGNITION METHOD

(71) Applicant: HONDA MOTOR CO., LTD., Tokyo (JP)

(72) Inventors: Masanori Yoshihira, Wako-shi (JP); Tadaaki Hasegawa, Wako-shi (JP)

(21) Appl. No.: 19/549,171

(22) Filed: Feb. 25, 2026

(30) Foreign Application Priority Data
Mar. 17, 2025 (JP) 2025-042223

(51) Int. Cl. G06V 10/26; G06V 10/44; G06V 10/82; G06V 20/50; G06V 20/70

(52) U.S. Cl. CPC G06V 10/26; G06V 10/44; G06V 10/82; G06V 20/50; G06V 20/70

(57) ABSTRACT

An object recognition device includes an acquisition unit configured to acquire image information representing environment information including a target object; a segmentation unit configured to divide the environment information from the image information into a plurality of segments; a feature extraction unit configured to extract a feature quantity for each of the segments; a graph representation generation unit configured to construct a graph in which the segments are defined as nodes and edges are defined on the basis of the feature quantities; a labeling unit configured to estimate labels of the nodes and labels of the edges from the graph through a graph neural network (GNN); and an integration unit configured to integrate segment groups constituting the same object on the basis of the obtained labels.

### CROSS-REFERENCE TO RELATED APPLICATION

This application claims priority based on Japanese Patent Application No. 2025-042223 filed in Japan on Mar. 17, 2025, and the entire contents thereof are incorporated herein by reference.

### BACKGROUND OF THE INVENTION

### Field of the Invention

The present invention relates to an object recognition device, and an object recognition method.

### Description of Related Art

In recent years, object detection and segmentation technologies using deep learning have made remarkable progress, and for example, highly accurate instance segmentation for rigid objects has been realized by using a model such as Mask R-CNN. Segmentation technology is, for example, a technology for identifying subjects captured in an image and identifying into which class the subjects are divided on a pixel-by-pixel basis. Instance segmentation is one of computer vision tasks using deep learning in which an accurate pixel-by-pixel boundary of individual object instances in an image is predicted.

For example, in control of a robot having a hand, for example, a point cloud is acquired from an image captured by a depth camera capable of acquiring depth information, and this point cloud is input to a trained model to generate a gripping posture (see, for example, Patent Document 1 below).

In industrial use (for example, picking or folding by a robot, and handling of medical materials or textile products), accurately recognizing a flexible object is an important issue for improvement of work efficiency or improvement of quality.

[Patent Document 1] Japanese Unexamined Patent Application, First Publication No. 2022-24952

### SUMMARY OF THE INVENTION

However, for example, in the case of a flexible object such as a handkerchief, cloth, or vinyl, due to characteristics such as the fact that a shape of an object easily changes, wrinkles or folds occur, and a boundary with a background becomes ambiguous, accurate recognition has been difficult with related art. In the related art, complex change in a shape of the flexible object or interaction of the flexible object with other objects cannot be accurately ascertained.

An aspect according to the present invention has been made in view of the above-described problems, and an object thereof is to provide an object recognition device and an object recognition method capable of accurately ascertaining complex change in a shape of a flexible object or interaction of the flexible object with other objects.

In order to solve the above problem and achieve the above object, the present invention adopts the following aspects.

(1) An object recognition device according to one aspect of the present invention includes: an acquisition unit configured to acquire image information representing environment information including a target object; a segmentation unit configured to divide the environment information from the image information into a plurality of segments; a feature extraction unit configured to extract a feature quantity for each of the segments; a graph representation generation unit configured to construct a graph in which the segments are defined as nodes and edges are defined on the basis of the feature quantities; a labeling unit configured to estimate labels of the nodes and labels of the edges from the graph through a graph neural network (GNN); and an integration unit configured to integrate segment groups constituting the same object on the basis of the obtained labels.

(2) In the aspect (1), the image information may include continuous image frames, and the labeling unit may accumulate and learn data moving together with the labels of segments and distances between the image frames, perform node association in preceding and following frames, and further input the node-associated information to the GNN.

(3) In the aspect (1) or (2), the segmentation unit may perform fine region segmentation on the image using a semantic segmentation model for the image information, to generate a plurality of segments that cover fine folds, wrinkles, and complex contours of the target object without excess or deficiency, and may not perform labeling.

(4) In any one of the aspects (1) to (3), the graph representation generation unit may construct the graph modeled such that the segments serve as the nodes and spatial and contextual relevance between the segments serve as the edges, in order to represent relationships between the segments obtained by processing of the segmentation unit, and the relationships may include relationships of being a part of the same object, an end effector manipulating the target object holding the target object, and being a different object but being in a contact state.

(5) In any one of the aspects (1) to (4), the target object may be the flexible object. (6) In any one of the aspects (1) to (5), the object recognition device may further include: an estimation unit configured to estimate a position, a shape, and a posture of the integrated target object; and a dynamic planning unit configured to, using an estimation result of the estimation unit, generate at least one operation plan among picking, folding, and moving for an end effector that manipulates the target object.

(7) An object recognition method according to one aspect of the present invention includes: acquiring image information representing environment information including a target object; dividing the environment information from the image information into a plurality of segments; extracting a feature quantity for each of the segments; constructing a graph in which the segments are defined as nodes and edges are defined on the basis of the feature quantities; estimating labels of the nodes and labels of the edges from the graph through a graph neural network (GNN); and integrating segment groups constituting the same object on the basis of the obtained labels.

According to the aspects (1) to (7), it is possible to accurately ascertain complex change in a shape of the flexible object or interaction of the flexible object with other objects, and perform accurate recognition and automatic processing.

### BRIEF DESCRIPTION OF THE DRAWINGS

FIG. 1 is a diagram illustrating an example of a configuration of an object recognition system according to an embodiment.

FIG. 2 is a diagram illustrating an example of a configuration of a work system including the object recognition system according to the embodiment.

FIG. 3 is a diagram illustrating an example of a result of segmentation processing of an image obtained by imaging a state in which a handkerchief having folds and the like is present in a work space.

FIG. 4 is a diagram illustrating an example in which labeling processing is performed after the segmentation processing of FIG. 3.

FIG. 5 is a diagram illustrating an example of graph representation and an example of labeling processing.

FIG. 6 is a diagram illustrating an example of labeling processing when a captured image is a moving image.

FIG. 7 is a diagram illustrating an example in which labels are assigned by integration processing.

FIG. 8 is a flowchart of processing performed by the object recognition device according to the embodiment.

FIG. 9 is a diagram illustrating an example of an object recognition result in the related art and an example of an object recognition result in a technique according to the present embodiment.

### DETAILED DESCRIPTION OF THE INVENTION

Hereinafter, embodiments of the present invention will be described with reference to the drawings. In the drawings used in the following description, scales of respective members are appropriately changed in order to make each member recognizable.

In all drawings for describing the embodiments, those having the same functions are denoted by the same reference signs, and repeated description is omitted.

In the present application, “based on XX” means “based on at least XX,” and includes being based on another element in addition to XX. “Based on XX” is not limited to a case in which XX is directly used, and includes being based on something obtained by performing calculation or processing on XX is an arbitrary element (for example, arbitrary information).

### Overview

In the present embodiment, it is possible to accurately ascertain complex change in a shape of the flexible object or interaction of the flexible object with other objects by performing the following processing.
(i) High-accuracy segmentation of the flexible object: This corresponds to fine shape change or unclear contour, and the flexible object in the image is reliably extracted.
(ii) Accurate ascertaining of a relationship between segments: A situation in which a plurality of segments constitute one flexible object or the flexible object and another object are combined is accurately reconstructed, and appropriate labeling is performed.
(iii) Handling a dynamic situation: Information is acquired from consecutive frames, and a time-varying state such as a situation in which the flexible object and a robot hand are in contact with each other and move integrally is accurately understood.
(iv) Improvement in efficiency of data preparation: efforts required for preparing training data is reduced by using data augmentation, transfer learning, and simulation.

### Configuration Example of Object Recognition System

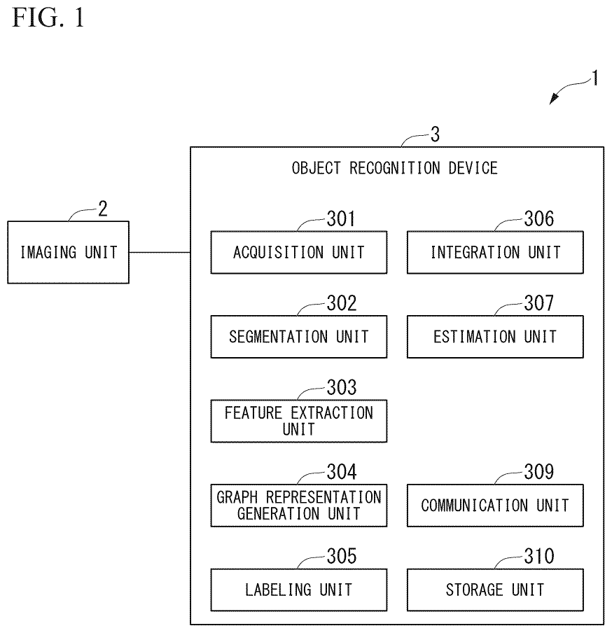

FIG. 1 is a diagram illustrating a configuration example of an object recognition system according to the present embodiment. The object recognition system 1 includes, for example, an imaging unit 2 and an object recognition device 3.

The object recognition device 3 includes, for example, an acquisition unit 301, a segmentation unit 302, a feature extraction unit 303, a graph representation generation unit 304, a labeling unit 305, an integration unit 306, an estimation unit 307, a communication unit 309, and a storage unit 310.

The object recognition device 3 and the imaging unit 2 are connected by wire or wirelessly.

The imaging unit 2 captures an image including an object that is a work target. The imaging unit 2 may be a depth camera capable of obtaining depth information or may be a two-dimensional RGB (red-green-blue) camera and a distance meter. The imaging unit 2 captures a moving image, or a still image for each frame. The imaging unit 2 may be installed in a work environment. The number of imaging units 2 may be two or more.

The object recognition device 3 estimates, from the image captured by the imaging unit 2, a position, a shape (degree of wrinkles, and spread), and a posture of the flexible object to recognize an object.

The acquisition unit 301 acquires the image captured by the imaging unit 2.

The segmentation unit 302 includes a trained semantic segmentation model. The semantic segmentation model may be placed in a cloud or may be stored in, for example, a server connected via a network. The segmentation unit 302 executes, for example, high-accuracy pixel-level segmentation on the basis of the acquired image using U-Net, DeepLab, or the like, and divides the image into a plurality of segments (minute regions). The segmentation unit 302 performs, for example, detailed contour extraction, distinction of a fine structure (wrinkles and slack) of a flexible object surface, and clarification of boundaries with a background.

The feature extraction unit 303 extracts, for each segment, feature quantities such as color, texture, position information, and depth information (as needed).

The graph representation generation unit 304 uses the segments as nodes to form edges on the basis of features such as proximity, similarity, positional relationship, and contact relationship.

The labeling unit 305 uses, for example, a graph neural network (GNN) to simultaneously estimate a node label (for example, whether a segment is a part of the flexible object, a hand, or a background) indicating a type of the segment or the like, and an edge label (for example, an internal relationship within the same object, a holding relationship, or a contact relationship) indicating a type of a feature between nodes, or the like. When a captured image is a moving image frame, the labeling unit 305 performs node association between preceding and following frames, and also processes time-series relationship change by using a GNN or an extended time-series model. The GNN is a type of deep learning model for processing data having a graph structure.

The integration unit 306 integrates segment groups constituting the same flexible object on the basis of the obtained labels and relationship information, assigns labels, and determines a final object.

The estimation unit 307 estimates a position, a shape (degree of wrinkles and spread), and a posture of the integrated flexible object.

The communication unit 309 outputs the estimated result to an external device (for example, a computer, a smartphone, a tablet terminal, a dedicated device, or a robot).

The storage unit 310 stores algorithms, formulas, predetermined values, and the like used by respective processing units.

### Configuration Example of Work System Including Object Recognition System

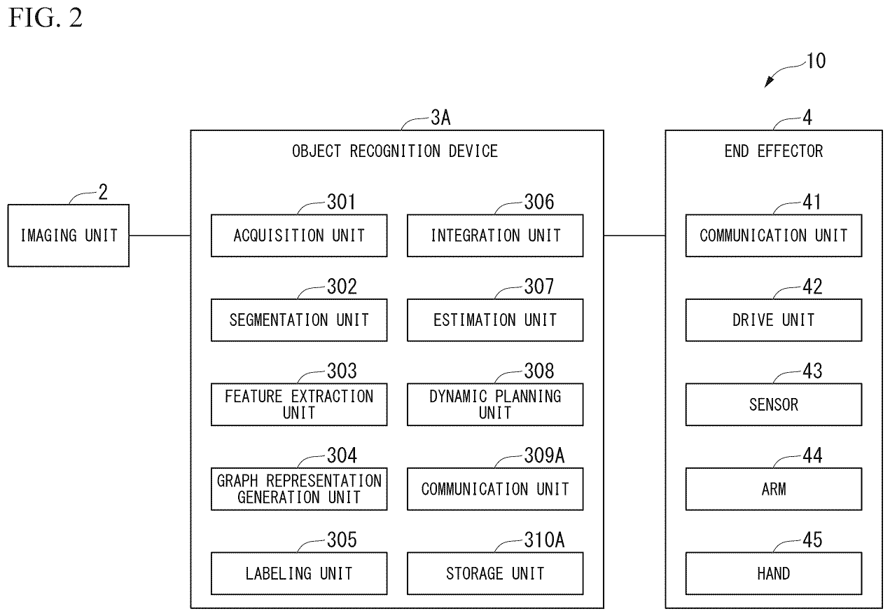

FIG. 2 is a diagram illustrating a configuration example of a work system including an object recognition system according to the present embodiment. The work system 10 includes, for example, the imaging unit 2, an object recognition device 3A, and an end effector 4.

The object recognition device 3A includes, for example, the acquisition unit 301, the segmentation unit 302, the feature extraction unit 303, the graph representation generation unit 304, the labeling unit 305, the integration unit 306, the estimation unit 307, a dynamic planning unit 308, a communication unit 309A, and a storage unit 310A. The end effector 4 includes, for example, a communication unit 41, a drive unit 42, a sensor 43, an arm 44, and a hand 45.

The object recognition device 3A and the imaging unit 2 are connected by wire or wirelessly. The object recognition device 3A and the end effector 4 are connected to each other by wire or wirelessly.

The object recognition device 3A estimates, from the image captured by the imaging unit 2, for example, a range and a shape of a first object and a positional relationship of the first object with a second object, and creates a work plan for the end effector 4. The work content is, for example, to spread a folded cloth (first object) that is the flexible object and place the cloth on a table (the second object). In a work of spreading the flexible object, for example, in a case of paper or the like, there is concern that the paper may tear when all folds or wrinkles are eliminated, and therefore, for example, when a predetermined area or thickness is reached, it is determined that the paper has “spread” and this state is set as a goal.

The dynamic planning unit 308 plans an operation plan such as picking, folding, and moving by using an estimation result of the estimation unit 307 and a state of the end effector 4 acquired by the communication unit 309A, and generates an operation instruction. The dynamic planning unit 308 performs feedback control during operation as needed, and corrects the operation in accordance with a change in position and shape of the flexible object.

The communication unit 309A acquires a detection result of the sensor 43 of the end effector 4. The communication unit 309A outputs the operation instruction generated by the dynamic planning unit 308 to the end effector 4.

The storage unit 310A stores algorithms, formulas, predetermined values, and the like used by respective processing units. The storage unit 310A stores algorithms, constraints, formulas, predetermined values, and the like necessary for generation of dynamic planning. The storage unit 310A stores a position at which the sensor 43 is attached, identification information for identifying each sensor, a type of each sensor, and the like in association.

The end effector 4 includes, for example, the arm 44 and the hand 45.

The communication unit 41 outputs a detection result of the sensor 43 to the object recognition device 3A. The communication unit 41 acquires the operation instruction from the object recognition device 3A.

The drive unit 42 includes, for example, an actuator or a drive circuit, and is attached, for example, to each joint of the arm 44 or the hand 45.

The sensor 43 is, for example, a tactile sensor that detects a force applied to a finger portion or a palm, a force sensor that detects a three-axis force applied to a finger and torque around each axis, and a posture sensor that detects a joint angle of the arm 44 or a joint angle of each finger.

The arm 44 includes joints. One end of the arm 44 is connected to, for example, a base portion, and the other end is connected to the hand 45 via joints.

The hand 45 includes, for example, two or more finger portions. The hand 45 may include a palm. Each finger portion includes joints.

### Segmentation Processing

Next, an example of segmentation processing performed by the segmentation unit 302 will be described.

The segmentation unit 302 performs fine region segmentation (over-segmentation) on the image for an image input by using a high-accuracy semantic segmentation model such as U-Net or DeepLab.

The semantic segmentation model is a model that creates a segmentation map of an input image.

U-Net is one fully convolution network (FCN) and is a network for estimating segmentation of an image (where an object is located). DeepLab is a deep learning model exhibiting high performance in an image recognition task called semantic segmentation.

Thus, the segmentation unit 302 generates a plurality of segments (minute pixel regions) that cover fine folds, wrinkles, complex contours, and the like of the flexible object without excess or deficiency.

However, at this stage, labeling is not performed, and the processing is purely specialized to subdividing the image into segment units. Thus, in the present embodiment, “segmentation accuracy” is maximized.

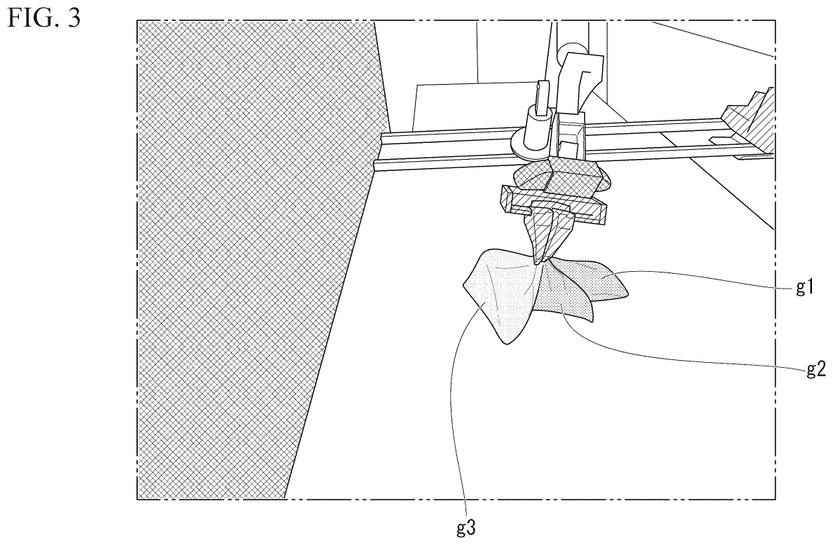

FIG. 3 is a diagram illustrating an example of a result of segmentation processing of an image obtained by imaging a state in which a handkerchief having folds and the like is present in a work space. In the example illustrated in FIG. 3, an end effector, a wall of the work space, and the like are also shown in the captured image.

In FIG. 3, each hatching indicates an example of each segment region. In FIG. 3, an object to be recognized is, for example, a handkerchief, and corresponds to hatched regions g1, g2, and g3.

As in FIG. 3, at this stage, contour extraction, clarification of a boundary with the background, and distinction of fine structures (for example, wrinkles and slack) of the surface of the flexible object are performed, but the handkerchief has not yet been recognized as one object.

### Feature Extraction Processing

Next, an example of processing performed by the feature extraction unit 303 will be described.

The feature extraction unit 303, for example, extracts, for each segment, feature quantities such as color, texture, position information, and depth information (as needed) by using, for example, a feature quantity extraction algorithm. The feature quantity extraction algorithm may extract the feature quantities by using, for example, a trained model such as a convolutional neural network (CNN), visual geometry group (VGG), or residual network (ResNet). Alternatively, the feature extraction unit 303 may extract the feature quantities by using a known technique such as Haar-like feature quantities, Histograms of Oriented Gradients (HOG) feature quantities, or Scale-Invariant Feature Transform (SIFT) feature quantities.

### Labeling Processing

Next, an example of labeling processing performed by the labeling unit 305 will be described.

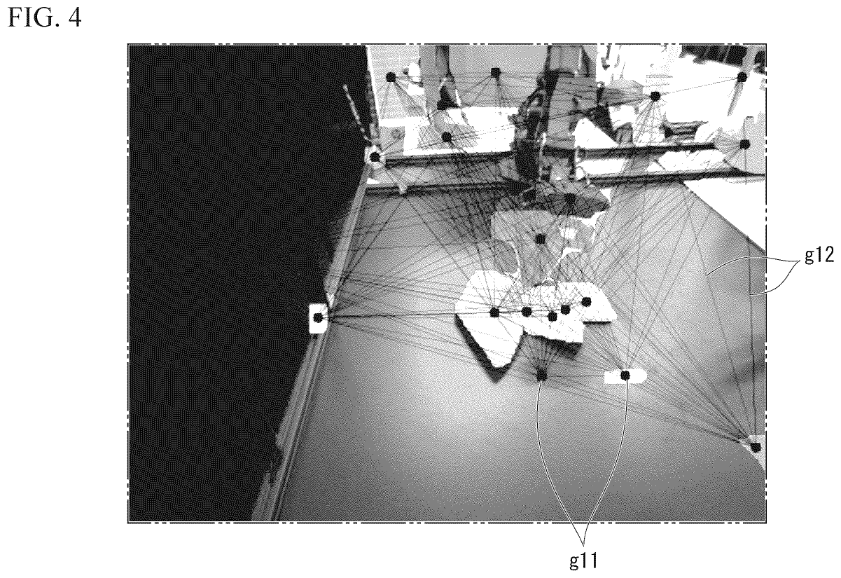

FIG. 4 is a diagram illustrating an example in which labeling processing is performed after the segmentation processing of FIG. 3. In FIG. 4, a circle mark g11 indicates a node, and a line g12 indicates an edge.

The labeling unit 305 uses the segments as nodes and forms edges indicating relationships between nodes on the basis of features such as proximity, similarity, positional relationship, and contact relationship. The labeling unit 305 uses, for example, a GNN to simultaneously estimate the node labels (for example, whether a segment is a part of the flexible object, a hand, or a background) and the edge label (for example, an internal relationship within the same object, a holding relationship, or a contact relationship).

The relationships include relationships specific to the flexible object, such as “being a part of the same flexible object,” “a robot hand holds the flexible object,” and “being a different object but being in a contact state.”

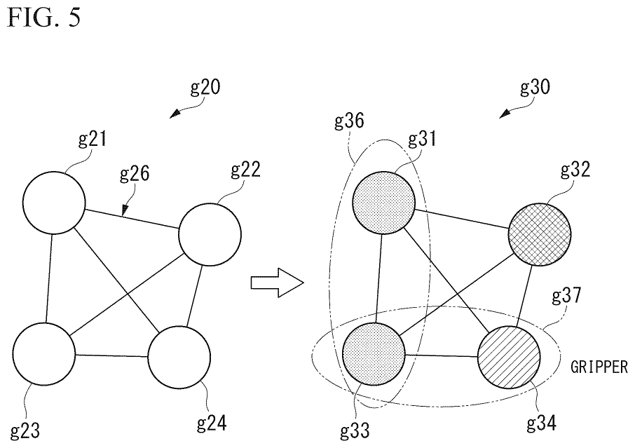

FIG. 5 is a diagram illustrating an example of graph representation and an example of labeling processing.

An image denoted by reference sign g20 is an example of graph representation after nodes and edges are estimated. Circles g21 to g24 are nodes, and a line g26 connecting nodes is an edge. At this stage, labeling is not performed on each node.

An image denoted by reference sign g30 is an example after labeling.

As a result of estimation based on relationships between nodes, nodes g31 and g33 are estimated to be nodes of the flexible object, and are estimated to be the same object as indicated by an ellipse g36. Node g32 is estimated to be an environmental object (for example, other than the target object and the end effector 4), and node g34 is estimated to be a gripper that is the hand 45 of the end effector 4. As indicated by an ellipse g37, nodes g33 and g34 are estimated to be an object being gripped.

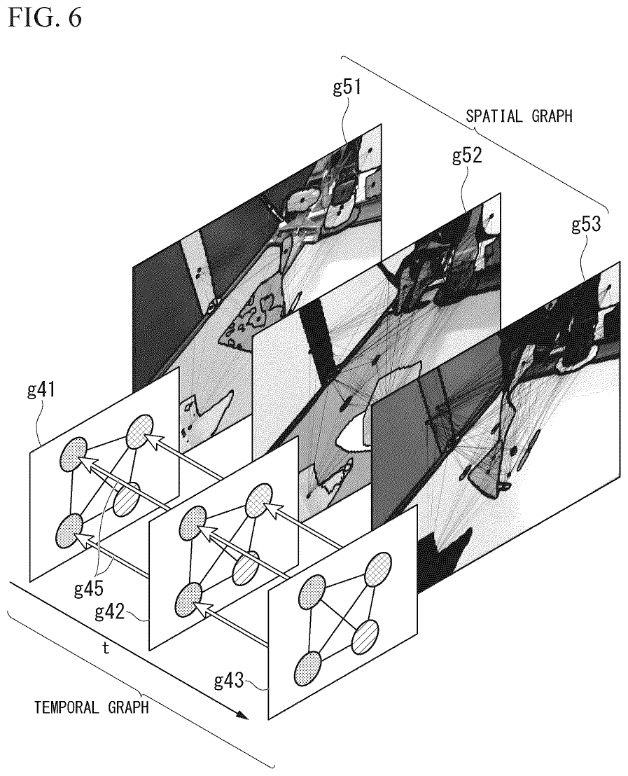

FIG. 6 is a diagram illustrating an example of labeling processing when the captured image is a moving image. Images denoted by reference signs g41 to g43 are temporal graphs, and a horizontal axis indicates time (frames). An arrow g45 indicates an image of node association between preceding and following frames.

Images denoted by reference signs g51 to g53 are spatial graphs.

Thus, in the present embodiment, in a case of moving image frames, node association is performed between preceding and following frames, and a time-series relationship change is processed by the GNN or an extended time-series model. In the present embodiment, when acquired images are continuous images, the labeling unit 305 accumulates and learns data moving together with the labels of segments and distances between the image frames, performs node association in the frames, and further inputs the node-associated information to the GNN.

### Integration Processing

Next, an example of integration processing performed by the integration unit 306 will be described.

The integration unit 306 analyzes a graph through a GNN, for example, to estimate labels of nodes (segments) (for example, whether the node is a part of the flexible object, the hand, or the background) and edges (relationships between segments). Thus, according to the present embodiment, it becomes possible to integrate a plurality of divided segments and identify the integrated segments as one flexible object, and to correctly understand a situation in which the flexible object and a hand move integrally.

By such processing, the integration unit 306 integrates segment groups constituting the same flexible object on the basis of the obtained labels and relationship information, and determines a final object.

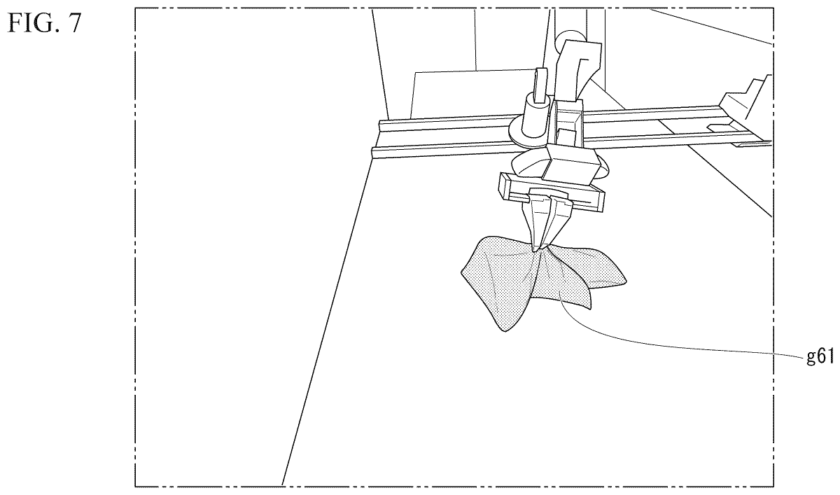

FIG. 7 is a diagram illustrating an example in which labels are assigned through integration processing. Reference sign g61 is an image of an integrated object. As indicated by reference sign g61, integration as one object is achieved, and folds and the like are also appropriately recognized.

### Estimation Processing

Next, an example of estimation processing performed by the estimation unit 307 will be described.

The estimation unit 307 estimates a position, a shape (degree of wrinkles, spread), and a posture of the integrated flexible object using a known image recognition technique or, for example, a technique described in Japanese Patent Application No. 2024-216291.

### Dynamic Planning Processing

Next, an example of processing performed by the dynamic planning unit 308 will be described.

The dynamic planning unit 308 acquires information from continuous image frames (moving image) and uses time-series information. Specifically, a segmentation→labeling cycle is performed for each frame to incorporate segment correspondence relationships (tracking) between preceding and following frames into an input to the GNN, thereby capturing a position, a shape, and a contact relationship between the flexible object and the hand that change on a time axis.

Thus, according to the present embodiment, it is possible to accurately analyze a dynamic situation in which the flexible object moves or deforms together with the hand 45 by explicitly considering node (segment) association between frames and continuation and variation of edges (relationships).

The dynamic planning unit 308 generates the operation instruction at predetermined time intervals and outputs the generated operation instruction to the end effector 4.

Models used by the functional units described above are used after learning is performed using images of respective states and respective postures for each target object to be recognized, and teacher data. The models may be updated during use. Each model may be placed on a cloud or may be stored in a server.

According to the present embodiment, the above-described processing makes it possible to obtain a learning model capable of handling diverse forms of flexible objects by combining data augmentation technologies (shape deformation and simulation of lighting change), pseudo-data generation using a simulation environment, utilization of transfer learning, and the like. Thus, according to the present embodiment, it is possible to reduce the effort required for preparing training data without relying on the collection of a vast amount of real image data.

### Example of Processing Procedure of Object Recognition Device

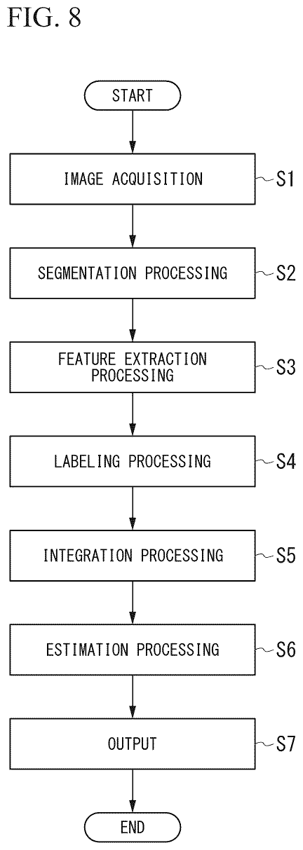

FIG. 8 is a flowchart of processing performed by the object recognition device according to the present embodiment.

(Step S1) The acquisition unit 301 acquires the image captured by the imaging unit 2.

(Step S2) The segmentation unit 302 performs fine region segmentation on the acquired image using, for example, a semantic segmentation model of U-Net.

(Step S3) The feature extraction unit 303, for example, extracts, for each segment, feature quantities such as color, texture, position information, and depth information using, for example, a feature quantity extraction algorithm.

(Step S4) The labeling unit 305 uses segments as nodes to form edges on the basis of, for example, features such as proximity, similarity, positional relationship, and contact relationship.

(Step S5) The integration unit 306 analyzes the graph through the GNN to estimate, for example, labels and edges of nodes (segments).

(Step S6) The estimation unit 307 estimates a position, a shape, and a posture of the integrated flexible object.

(Step S7) The communication unit 309 outputs an estimated result to an external device as an object recognition result.

The processing content illustrated in FIG. 7 is an example and is not limited thereto. Other processing may also be performed.

For example, when the end effector 4 is controlled using an object recognition result, the dynamic planning unit 308 plans an operation plan such as picking, folding, and moving by using the estimation result of the estimation unit 307 and the state of the end effector 4 acquired by the communication unit 309A, and generates an operation instruction, instead of step S7. Since a shape, a posture, or the like of the target object changes due to control, the object recognition device 3A repeats processing of steps S1 to S7 at predetermined time intervals.

### Comparison

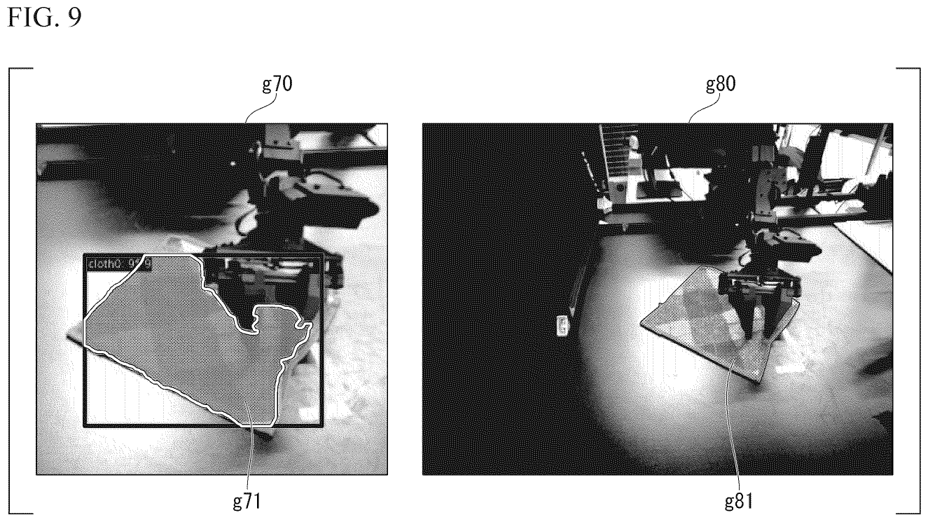

FIG. 9 is a diagram illustrating an example of an object recognition result in the related art and an example of an object recognition result in the technique according to the present embodiment.

An image denoted by reference sign g70 is an example in which the flexible object is recognized by using the related art. In this case, due to influence of occlusion due to the hand 45, wrinkles, folds, reflections, and the like, a target object (for example, a handkerchief) cannot be recognized in an appropriate range or shape as indicated by reference sign g71.

An image denoted by reference sign g80 is an example of an object recognition result in the technique according to the present embodiment. As indicated by reference sign g81, with the technique according to the present embodiment, it is possible to appropriately estimate an outer shape, a shape, a posture, and the like of the flexible object even when there is an influence of occlusion, wrinkles, folds, reflections, and the like.

As described above, in the present embodiment, segmentation and labeling (relationship assignment) are clearly separated and processing is performed in two stages. Further, in the present embodiment, processing as illustrated in FIG. 8 is performed.

Thus, according to the present embodiment, it is possible to accurately ascertain complex change in a shape of the flexible object or interaction of the flexible object with other objects, and to achieve accurate recognition and automatic processing. Thus, according to the present embodiment, improvement in productivity and improvement in work accuracy, for example, in robot work, manufacturing, and medical sites that handle

### Flexible Objects Can Be Expected.

In the above-described example, the handkerchief, which is cloth, has been described as an example of the flexible object, but the flexible object is not limited thereto. The flexible object may be, for example, paper or vinyl.

In the above-described work example, an example in which the flexible object is spread has been described, but the work is not limited thereto. The work may be, for example, work of folding clothing and placing the clothing on a table or spreading a plastic bag, putting the plastic bag into a plastic bucket, and covering an upper portion of the plastic bucket with an upper portion of the plastic bag.

A program for realizing all or some of functions of the object recognition device 3 (or 3A) in the present invention may be recorded in a computer-readable recording medium, and the program recorded in the recording medium may be read and executed by a computer system to perform all or some of processing performed by the object recognition device 3 (or 3A). Here, the “computer system” is assumed as including an OS and hardware such as peripheral devices. The “computer system” is also assumed as including a WWW system including a homepage providing environment (or a display environment). The “computer-readable recording medium” refers to a portable medium such as a flexible disk, a magneto-optical disk, a ROM, and a CD-ROM, and a storage device such as a hard disk incorporated in a computer system. Further, the “computer-readable recording medium” also includes a medium that holds a program for a certain period of time, such as a volatile memory (RAM) in a computer system that serves as a server or a client when the program is transmitted via a network such as the Internet or a communication line such as a telephone line.

Alternatively, some or all of these components may be realized by hardware (including circuitry) such as a large scale integration (LSI), an application specific integrated circuit (ASIC), a field-programmable gate array (FPGA), a graphics processing unit (GPU), or a system on chip (SOC), or may be realized by cooperation of software and hardware.

The above-described program may be transmitted, from a computer system storing the program in a storage device or the like, to another computer system via a transmission medium or using transmission waves in the transmission medium. Here, the “transmission medium” that transmits the program refers to a medium having a function of transmitting information, like a network (communication network) such as the Internet or a communication line such as a telephone line. The program may be a program for realizing some of the above-described functions. Further, the program may be a program that can realize the above-described functions in a combination with a program already recorded in a computer system, that is, a so-called difference file (difference program).

Although the embodiments for carrying out the present invention have been described above by using embodiments, the present invention is not limited to such embodiments at all, and various modifications and substitutions may be made without departing from the gist of the present invention.

What is claimed is:

1. An object recognition device comprising:
an acquisition unit configured to acquire image information representing environment information including a target object;
a segmentation unit configured to divide the environment information from the image information into a plurality of segments;
a feature extraction unit configured to extract a feature quantity for each of the segments;
a graph representation generation unit configured to construct a graph in which the segments are defined as nodes and edges are defined on the basis of the feature quantities;
a labeling unit configured to estimate labels of the nodes and labels of the edges from the graph through a graph neural network (GNN); and
an integration unit configured to integrate segment groups constituting the same object on the basis of the obtained labels.

2. The object recognition device according to claim 1, wherein
the image information includes continuous image frames, and
the labeling unit accumulates and learns data moving together with the labels of segments and distances between the image frames, performs node association in preceding and following frames, and further inputs the node-associated information to the GNN.

3. The object recognition device according to claim 1, wherein the segmentation unit performs fine region segmentation on the image using a semantic segmentation model for the image information, to generate a plurality of segments that cover fine folds, wrinkles, and complex contours of the target object without excess or deficiency, and does not perform labeling.

4. The object recognition device according to claim 1, wherein
the graph representation generation unit constructs the graph modeled such that the segments serve as the nodes and spatial and contextual relevance between the segments serve as the edges, in order to represent relationships between the segments obtained by processing of the segmentation unit, and
the relationships include relationships of being a part of the same object, an end effector manipulating the target object holding the target object, and being a different object but being in a contact state.

5. The object recognition device according to claim 1, wherein the target object is the flexible object.

6. The object recognition device according to claim 1, further comprising:
an estimation unit configured to estimate a position, a shape, and a posture of the integrated target object; and
a dynamic planning unit configured to, using an estimation result of the estimation unit, generate at least one operation plan among picking, folding, and moving for an end effector that manipulates the target object.

7. An object recognition method comprising:
acquiring image information representing environment information including a target object;
dividing the environment information from the image information into a plurality of segments;
extracting a feature quantity for each of the segments;
constructing a graph in which the segments are defined as nodes and edges are defined on the basis of the feature quantities;
estimating labels of the nodes and labels of the edges from the graph through a graph neural network (GNN); and
integrating segment groups constituting the same object on the basis of the obtained labels.
